(19) United States
(12) Patent Application Publication
(10) Pub. No.: US 2011/0106603 A1
(43) Pub. Date: May 5, 2011

(54) Self-Service Implementation of Digital Coupons

(76) Inventors: Monica Theresa McCann, Seattle, WA (US); William W. Allocca, Bellevue, WA (US); Brandon R. I. Chang, Seattle, WA (US); Henry Robert Nickerson, Seattle, WA (US); Mark S. Gulbrandsen, Seattle, WA (US); Douglas J. Herrington, Seattle, WA (US); Dilip S. Kumar, Seattle, WA (US); James J. Shimada, Seattle, WA (US); Paul D. DeMarco, Seattle, WA (US)

(21) Appl. No.: 12/608,673

(22) Filed: Oct. 29, 2009

(51) Int. Cl. G06Q 30/00

(52) U.S. Cl. 705/14.21; 705/14.39

(57) ABSTRACT

Disclosed are various embodiments relating to a self-service portal for coupon implementation in association with an electronic commerce system. Coupon campaigns are implemented in a computing device for a plurality of vendors in association with the electronic commerce system. Each of the coupon campaigns comprises one or more digital coupons. An automated submission of each of the campaigns is facilitated in the computing device from respective ones of the vendors through a self-service portal. Vendor control is facilitated through the self-service portal as to whether the digital coupons associated with a respective one of the campaigns are activated to be applied to a purchase of an item through the electronic commerce system.

### BACKGROUND

Merchants who sell products over the Internet may wish to offer coupons to consumers in association with the online sale of goods. A problem can be presented in that implementing the many different coupons in association with the operation of a large online merchant can be burdensome and labor intensive.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment including various computing devices according to an embodiment of the present disclosure.

FIG. 2 is a drawing of one example of a user interface rendered on a display device of a computing device such as a client in the networked environment of FIG. 1 according to an embodiment of the present disclosure.

FIG. 3 is a drawing of another example of a user interface rendered on a display device of a computing device such as a client in the networked environment of FIG. 1 according to an embodiment of the present disclosure.

FIG. 4A is a flowchart that illustrates an example of functionality implemented in a computing device such as a server in the networked environment of FIG. 1 according to an embodiment of the present disclosure.

FIG. 4B is a flowchart that illustrates another example of functionality implemented in a computing device such as a server in the networked environment of FIG. 1 according to an embodiment of the present disclosure.

FIG. 5 is a schematic block diagram that illustrates one embodiment of a computing device such as a server in the networked environment of FIG. 1 according to an embodiment of the present disclosure.

### DETAILED DESCRIPTION

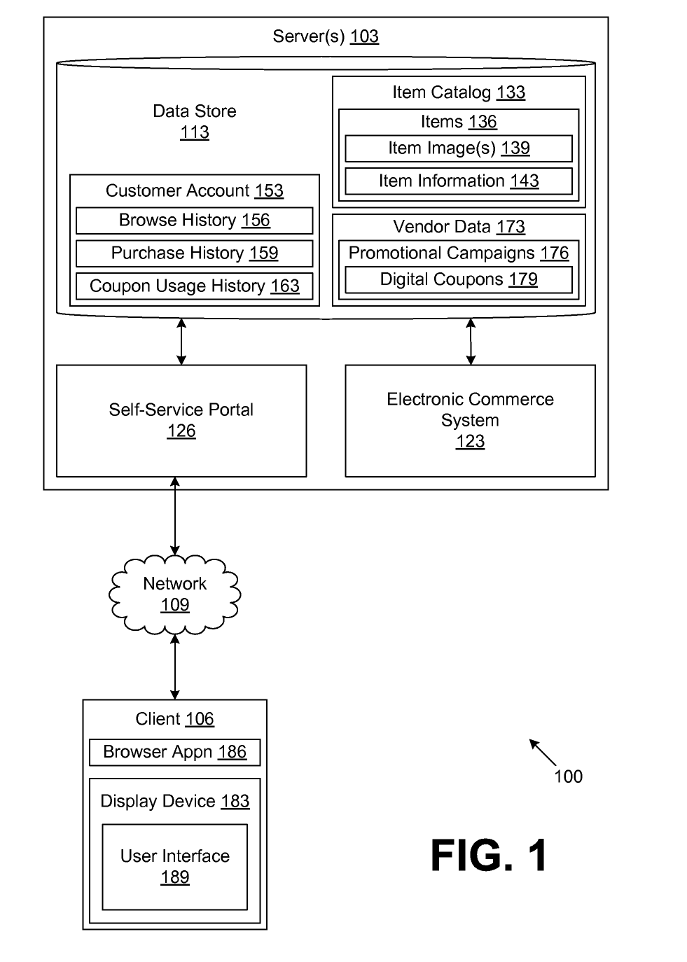

With reference to FIG. 1, the following relates to the implementation of coupons in a networked environment 100 in association with the activities of a merchant that sells goods and/or services online over a network such as the Internet. In the following discussion, first a description of the physical nature of the networked environment 100 is provided followed by a description of the operation of the same. More detailed discussion of various aspects is provided with respect to later figures.

The networked environment 100 depicted in FIG. 1 includes various computing devices such as, for example, a server 103, a client 106, and/or other computing devices that are coupled to a network 109. The network 109 may comprise, for example, the Internet, intranets, extranets, wide area networks (WANs), local area networks (LANs), wired networks, wireless networks, or other suitable networks, etc., or any combination of two or more such networks. For purposes of convenience, the server 103 and the client 106 are each referred to herein in the singular. However, it is understood that in one embodiment, the servers 103 may represent a plurality of servers, and the client 106 may represent a plurality of clients.

The server 103 comprises one example of a computing device that may be employed to execute various components as described here. The server 103 may comprise, for example, a server computer or like system, and may represent multiple servers arranged, for example, in one or more server banks or other arrangements. Such servers may be located in a single installation or may be dispersed among many different geographical locations. To this end, the server 103 may be viewed as a server “cloud” that represents the computing capacity of multiple servers, etc.

Various applications and/or engines are executed in the server 103 according to various embodiments. Also, various data may be stored in a data store 113 that is accessible to the server 103. The data stored in the data store 113, for example, may be associated with the operation of the various applications and/or engines described below. The applications executed in the server 103 may include, for example, an electronic commerce system 123, a self-service portal 126, and other applications not discussed in detail herein.

The electronic commerce system 123 is configured to conduct electronic commerce to facilitate the network presence of one or more online merchants. The electronic commerce system 123 may comprise may different applications, components, and/or systems implemented on a plurality of computing devices such as the server 103 that are located at one site, or are distributed among geographically diverse sites as can be appreciated.

The applications, components, and/or systems included in the electronic commerce system 123 provide for various functions such as maintaining and accessing an item catalog 133 in which is stored data describing a plurality of items 136 sold to customers by an online merchant. The data describing each of the items 136 may include item images 139 and item information 143. The items 136 sold through the electronic commerce system 123 may comprise, for example, goods and/or services. The electronic commerce system 123 may also provide for various functions such as, for example, searching for items 136, generating network pages with search results or for other purposes, implementing the purchase of items 136, effecting payment for items 136 purchased, and other functions. In providing for the purchase of items 136, the electronic commerce system 123 may generate a plurality of different network pages such as web pages or other network content that is served up to various clients 106 controlled by customers. Such network pages may be static or created dynamically.

In addition, various customer accounts 153 may be maintained in the data store 113. Each customer account 153 may include customer data that describes the customer including payment addresses, delivery addresses, payment instruments, and other data used to consummate various commercial transactions. Also associated with each of the customer accounts 153 are a browse history 156, purchase history 159, coupon usage history 163, and potentially other data. In one embodiment, the coupon usage history 163 may actually be included as part of the purchase history 159 as can be appreciated.

In addition, vendor data 173 is stored in the data store 113 that describes information about various vendors such as manufacturers and other types of vendors that produce or otherwise provide items 136 that are sold through the electronic commerce system 123. The vendor data 173 may include information about respective vendors including address and contact information, banking information, supply contract information, and other information not important for the purposes of this discussion that is needed to transact business with such vendors as can be appreciated. The vendor data 173 specifically includes data that describes various promotional campaigns 176 that are launched by vendors to provide greater incentives to their customers to purchase the items 136 they offer. According to one embodiment, one or more digital coupons 179 are associated with each of the promotional campaigns 176 as will be described. As contemplated herein, a digital coupon 179 comprises a digital instrument that may be selected by a user that entitles the user to redeem a benefit in association with a purchase of one or more items 136. Such a benefit may comprise, for example, a discount off of a purchase price for one or more items 136, whether the discount is a fixed dollar amount or a percentage of the purchase price. The benefit may also comprise, for example, giveaways of additional items 136, free shipping for items 136, discounts (fixed or percent reduction) for items 136 related to items 136 purchased, or other benefits.

According to various embodiments, the self-service portal 126 facilitates vendor access and specification of the promotional campaigns 176 and/or the digital coupons 179 that are associated with the promotional campaigns 176. In addition, the vendor data 173 may express agreements between a vender and the merchant that operates the electronic commerce system 123 with respect to the digital coupons 179 of the respective promotional campaigns 176. Such agreements express terms of payment and other terms associated with the usage of the digital coupons 179 by customers.

Various accounting functions may be included in the electronic commerce system 123 and/or the self-service portal 126 to track the usage of the digital coupons 179, amounts owed by a vendor to the merchant based on discounts due to the coupons, and other accounting functions.

The client 106 is representative of a plurality of client devices that may be coupled to the network 109. For example, the client 106 may comprise one of millions of clients 106 coupled to the Internet. The client 106 may comprise, for example, a processor-based system such as computer system. Such a computer system may be embodied in the form of a desktop computer, a laptop computer, a personal digital assistant, a cellular telephone, set-top box, music players, web pads, tablet computer systems, or other devices with like capability.

The client 106 may include, for example various peripheral devices. In particular, the peripheral devices may include input devices such as, for example, a keyboard, keypad, touch pad, touch screen, microphone, scanner, mouse, joystick, or one or more push buttons, etc. The peripheral devices may also include a display device 183, indicator lights, speakers, etc. The display device 183 may comprise, for example, cathode ray tubes (CRTs), liquid crystal display (LCD) screens, gas plasma-based flat panel displays, LCD projectors, or other types of display devices, etc.

Executed within the client 106 are various applications including a browser application 186. The client browser application 186 is configured to interact with the electronic commerce system 123 and potentially other applications on the server 103 according to an appropriate protocol such as the Internet Protocol Suite comprising Transmission Control Protocol/Internet Protocol (TCP/IP) or other protocols. To this end, the browser application 186 may comprise, for example, a commercially available browser such as INTERNET EXPLORER® sold by Microsoft Corporation of Redmond, Wash., or MOZILLA FIREFOX® which is promulgated by Mozilla Corporation of Mountain View, Calif., or other type of browser. Alternatively, the browser application 186 may comprise some other application with like capability. When executed in the client 106, the browser application 186 is configured to render user interfaces 189 in the form of network pages such as web pages and the like on the display device 183 and to perform other functions. Also, the browser application 186 may implement the execution of active portions of a network page as can be appreciated.

Next, the operation of the various components in the networked environment 100 is described. The promotional campaigns 176 are implemented in the server 103 for the respective vendors in association with the operation of the electronic commerce system 123. Each of the promotional campaigns 176 includes one or more digital coupons 179. Such digital coupons 179 are included in the network pages generated by the electronic commerce system 123 that are sent to respective clients 106 during the course of conducting online transactions for the purchase of items 136 by customers as can be appreciated. In order to maintain the various promotional campaigns 176, the self-service portal 126 provides a point of access for vendors to upload the promotional campaigns 176 and digital coupons 179 to the server 103 from a respective client 106. The self-service portal 126 facilitates an automated submission of each of the promotional campaigns 176 in the server 103 from vendors. Stated another way, the self-service portal 126 is “self-service” in that it allows vendors to remotely manage all of their promotional campaigns 176 and digital coupons 179 as they see fit without the need for intervention on the part of the merchant that operates the electronic commerce system 123.

Thus, the self-service portal 126 facilitates vendor control over the respective digital coupons 179 and the promotional campaigns 176. For example, vendors may access the promotional campaigns 176 and individual digital coupons 179 through the self-service portal 126 to specify whether such promotional campaigns 176 and/or digital coupons 179 are active to be applied for the purchase of items 136 through the electronic commerce system 123. A given digital coupon 179 is “active” when it may be drawn upon by the electronic commerce system 123 and included in network pages that are served up to clients 106 in order to be redeemed in conjunction with the purchase of items 136 through the electronic commerce system 123. A digital coupon 179 or promotional campaign 176 is considered “inactive” when the same is not available for use in conjunction with the purchase of items 136 through the electronic commerce system 123. The digital coupons 179 that are inactive cannot be included in network pages served up to clients 106 to implement the sale of items 136 as can be appreciated. Also, where a promotional campaign 176 is active, then one or more of the digital coupons 179 associated with such promotional campaign 176 may be active. However, when a promotional campaign 176 is deemed inactive, then all of the digital coupons 179 associated therewith are also deemed inactive.

One way that a vendor may exercise control over whether a given promotional campaign 176 or digital coupon 179 is/are active or inactive involves facilitating a vendor specification of a maximum expenditure limit associated with a given promotional campaign 176 or associated with individual ones of the digital coupons 179. A vendor may specify a maximum expenditure that is to be made under a given promotional campaign 176. If a maximum expenditure limit is associated with a given promotional campaign 176, then all active ones of the digital coupons 179 associated with the respective promotional campaign 176 are deactivated when the collective expenditure under all of the active ones of the digital coupons 179 associated with the respective promotional campaign 176 approaches the maximum expenditure limit associated with the promotional campaign 176.

In one approach, the digital coupons 179 associated with a promotional campaign 176 may be rendered inactive when the expenditure under the promotional campaign 176 reaches a predefined percentage of the maximum expenditure limit specified. All outstanding instances of the digital coupons 179 that were sent in network pages under the respective promotional campaign 176 are honored for a predefined period of time after the predefined percentage of a maximum expenditure limit associated with the promotional campaign 176 has been reached.

Thus, by specifying a predefined percentage of the maximum expenditure limit as a threshold for determining when to render the digital coupons 179 associated with a promotional campaign 176 inactive, one takes into account, for example, that digital coupons 179 may have been sent out by the electronic commerce system 123 with various network pages without knowledge as to whether consumers will actually redeem such digital coupons 179. It follows that even though a given threshold has been reached, it is still possible that further digital coupons 179 may be redeemed.

By specifying a predefined percentage of a maximum expenditure limit as a threshold to render either individual digital coupons 179 or promotional campaigns 176 inactive, an approximate control is provided such that even though instances of digital coupons 179 may remain outstanding for a short time after the threshold is reached, the total expenditure under the respective digital coupon 179 or promotional campaign 176 will presumably approach the actual predefined maximum expenditure limit. This assumes that the threshold is a predefined percentage of the maximum expenditure limit that is specified with knowledge of the rate at which certain digital coupons 179 are included in various network pages. Also, the rates of redemption of such digital coupons 179 may be known so that it can be estimated at what amount the threshold should be specified so that there is a relatively low likelihood that the maximum expenditure limit will be exceeded.

In order to specify the maximum expenditure limit associated with either a respective promotional campaign 176 or with a given digital coupon 179, the self-service portal 126 allows a given vendor to upload a spreadsheet or other data that specifies details of a given promotional campaign 176 including all of the digital coupons 179 associated with the promotional campaign 176. Alternatively, the spreadsheet or other data may specify individual digital coupons 179 that are not associated with a specific promotional campaign 176.

Such spreadsheet or other data may specify the respective maximum expenditure limits associated with a given promotional campaign 176 or associated with each of the digital coupons 179. In this manner, the vendor exercises a degree of control over when digital coupons 179 and promotional campaigns 176 are active as the maximum expenditure limits provide a degree of control as to how much money is to be spent on such promotional campaigns 176 and/or digital coupons 179.

As an alternative, rather than uploading a spreadsheet or other data that specify promotional campaigns 176 and/or individual digital coupons 179, the self-service portal 126 may serve up various network pages that have fields that allow vendors to enter such information therein. Such network pages may be employed to ultimately upload the data associated with promotional campaigns 176 and/or digital coupons 179 as can be appreciated.

In addition, the self-service portal 126 serves up various network pages with user interfaces that facilitate direct control by a vendor as to when respective digital coupons 179 of a promotional campaign 176 are active. Further, network pages may be generated by the self-service portal 126 that allow a vendor to specify or exercise direct control over whether a promotional campaign 176 is active as will be described.

In generating such network pages, the respective user interfaces are encoded for display on the display device 183 of a client 106 by operation of a browser application 186 or other appropriate application. Such user interfaces may include one or more components associated with the respective digital coupons 179 that facilitate the activation or deactivation of respective ones of the digital coupons 179. The same applies to the promotional campaigns 176 as well.

In addition, the user interfaces included in the network pages served up to the client 106 from the self-service portal 126 may include a listing of each of the promotional campaigns 176 that have been previously submitted by a vendor through the self-service portal 126. Also, in the same manner, a vendor may view a listing of each of the digital coupons 179 associated with a respective one of the promotional campaigns 176. Such user interfaces will be described in greater detail with respect to later figures.

In addition, when a spreadsheet or other data is initially uploaded to the self-service portal 126 by a vendor during the automated submission of one or more new promotional campaigns 176 that include various digital coupons 179, the self-service portal 126 may first analyze each of the promotional campaigns 176 submitted to identify errors. For example, the self-service portal 126 examines such promotional campaigns 176 or individual digital coupons 179 for missing data such as, for example, missing start dates, end dates, maximum expenditure limits, or other missing data as can be appreciated. In addition, other errors may be identified such as promotional campaigns 176 or digital coupons 179 that improperly identify items 136 to which they are directed. For example, the digital coupon 179 may be misdirected if the amount discounted off of the list price associated with the digital coupon 179 is greater than the price of the item 136, etc. Once the self-service portal 126 analyzes a respective promotional campaign 176 for errors, it may make available the result of the analysis to a vendor so that corrections may be made as necessary or to facilitate resubmission of a corrected promotional campaign 176 or digital coupon 179.

Once a digital coupon 179 is available for use by the electronic commerce system 123, then the electronic commerce system 123 may present the digital coupon 179 in various user interfaces 189 presented as network pages to clients 106. To this end, customers may click on or otherwise select digital coupons 179 while browsing various items 136 presented in various network pages. According to one embodiment, the electronic commerce system 123 tracks those digital coupons 179 selected by customers and applies the respective benefits offered by those digital coupons 179 at checkout when such items 136 are purchased. Alternatively, the redemption of digital coupons 179 may be implemented in some other manner.

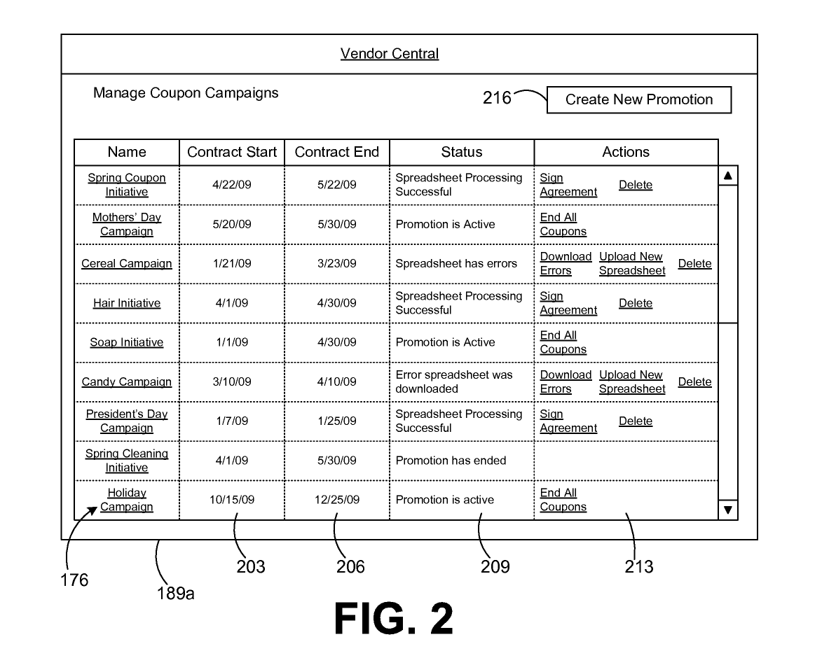

With reference to FIG. 2, shown is one example of a user interface 189a that may be generated on the display device 183 (FIG.1) of the client 106 (FIG. 1) by the browser application 186 (FIG. 1) after receiving one of the respective network pages encoded by the self-service portal 126 (FIG. 1). The user interface 189a includes a listing of each of the promotional campaigns 176 associated with a given vendor. Associated with each promotional campaign 176 in the listing is a contract start date 203 and a contract end date 206. The contract start date 203 and contract end date 206 specify a time period within which all of the digital coupons 179 associated with a respective promotional campaign 176 are to be active. Thus, each promotional campaign 176 specifies a time period for the activation of its digital coupons 179, given that various promotional campaigns 176 may be seasonal or may be timed in association with predefined holidays, etc. Since the start and end dates for individual digital coupons 179 associated with a given promotional campaign 176 vary, the contract start date 203 and the contract end date 206 may be specified as the earliest start date and the latest end date of the respective digital coupons 179.

The user interface 189a also lists a status 209 of each of the promotional campaigns 176 listed, and actions 213 that may be taken with respect to each promotional campaign 176. The actions 213 that may be taken may depend upon the specific status 209 of a given promotional campaign 176. For example, the status 209 of a given promotional campaign 176 may comprise, for example, “spreadsheet processing successful,” which indicates that the uploading of a spreadsheet or other data specifying a given promotional campaign 176 was successful and no errors were noted.

When the status 209 of a given promotional campaign 176 is “spreadsheet processing successful,” then the actions 213 may involve electronically signing an agreement or contract associated with the respective promotional campaign 176 to put it into effect, or deleting the promotional campaign 176 before it is implemented. The deletion of a promotional campaign 176 may occur due to the fact that the underlying reasons for the promotional campaign 176 may have changed, thereby mandating that the promotional campaign 176 to be deleted.

The status 209 may be that the “spreadsheet has errors” which indicates that errors have been detected within a given spreadsheet specifying a promotional campaign 176 when uploaded. Alternatively, such a status 209 may apply to data that was uploaded through various user interfaces 189 (FIG. 1) in network pages served up to a client 106 by the self-service portal 126. A vendor may be invited to upload a new replacement spreadsheet, specify new data, or perform other corrective actions 213. When the status 209 of a promotional campaign 176 is “spreadsheet has errors,” various actions 213 may be taken including downloading a listing of the errors detected, uploading a new replacement spreadsheet, deleting the promotional campaign 176 from consideration, or other actions 213.

The status 209 of a given promotional campaign 176 may also comprise “error spreadsheet was downloaded” which indicates that a listing of the errors detected had previously been downloaded. The actions 213 that may be taken in view of such status 209 include downloading the errors once again, uploading a new replacement spreadsheet, or deleting the promotional campaign 176 from consideration.

Another status 209 of a promotional campaign 176 may comprise “promotion is active” which indicates that the current date falls between the contract start data 203 and the contract end date 206. As such, the respective promotional campaign 176 and the digital coupons 179 associated therewith are currently active to be included in network pages generated by the electronic commerce system 123 for the purchase of items 136 (FIG. 1). The actions 213 that may be taken in this situation include ending the promotional campaign 176, thereby rendering the promotional campaign 176 inactive. In such case, all of the digital coupons 179 associated with such promotional campaign 176 are rendered inactive. Finally, another status 209 of a given promotional campaign 176 may comprise the fact that the promotional campaign 176 has ended as indicated. In addition, the status 209 may include other states specified for a promotional campaign 176.

In addition, the user interface 189a further includes a “create new promotion” button 216 that may be manipulated in order to cause subsequent network pages to be encoded and downloaded to the client 106 that facilitate the upload or entry of a new promotional campaign 176 by a vendor as can be appreciated. Such network pages may include the ability to browse on the client 106 to find a spreadsheet that is to be uploaded to the server 103 or to take other actions 213 so as to specify the information related to a new promotional campaign 176.

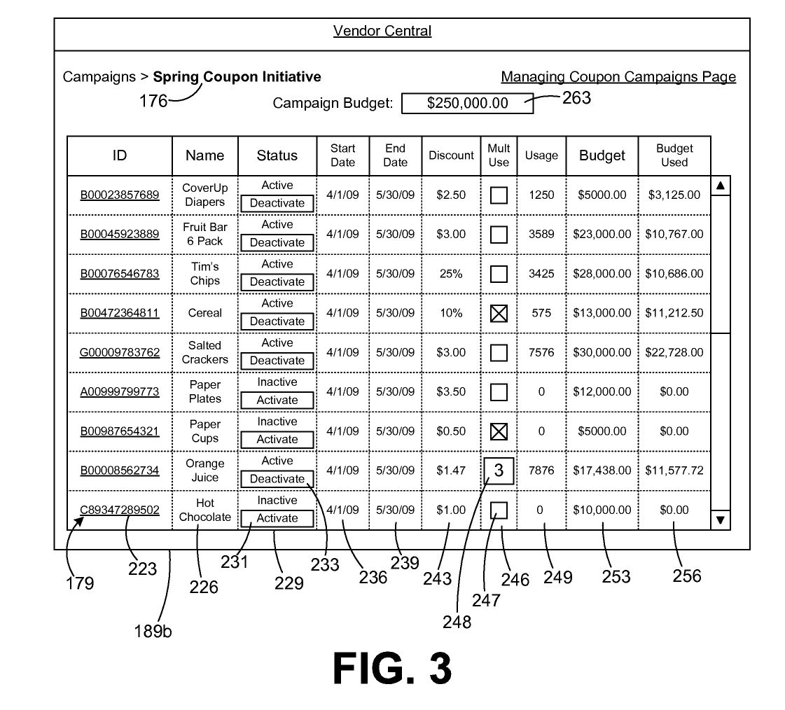

Referring next to FIG. 3, shown is an additional user interface 189b that is rendered on the display device 183 (FIG. 1) from a network page encoded by the self-service portal 126 (FIG. 1) and downloaded to the client 106 (FIG. 1). The user interface 189b advantageously lists each of the digital coupons 179 associated with a respective one of the promotional campaigns 176. In the listings shown, the parameters that specify each of the digital coupons 179 are included in the rows of a table that lists all of the digital coupons 179 of a respective promotional campaign 176.

Each of the digital coupons 179 is identified based upon an identifier 223 that may comprise, for example, a SKU number or other identifier of a respective item 136 (FIG. 1) or product as can be appreciated. Each digital coupon 179 is identified by a name 226 of the respective item 136 in the user interface 189b.

Also, an activation status 229 is listed for each of the digital coupons 179. The activation status 229 may be “active” or “inactive.” Each activation status 229 includes either an “activate” button 231 or a “deactivate” button 233. The activate button 231 may be manipulated by a vendor to change the activation status 229 of a given digital coupon 129 from inactive to active. Similarly, the deactivate button 233 may be manipulated in order to change the activation status 229 of a digital coupon 179 from “active” to “inactive.” In addition, associated with each of the digital coupons 179 are a start date 236 and an end date 239. The start date 236 and the end date 239 specify a time period within which the digital coupon 179 is to be active for use in association with the operation of the electronic commerce system 123 (FIG. 1). When a start date 236 occurs, the respective digital coupon 179 automatically is made active. Similarly, when an end date 239 occurs, a respective active digital coupon 179 is automatically deactivated. To the extent that the current date is outside of a time period specified by the start date 236 and the end date 239, in one embodiment, the self-service portal 126 will not allow a user to change the activation status 229 from inactive to active. Further, the vendor may change an activation status 229 from active to inactive within the respective time period as desired. Also, if a vendor has previously deactivated a digital coupon 179 between the start and end dates 236 and 239, then the vendor may reactivate the digital coupon 179 by manipulating the respective activate button 231.

In addition, associated with each of the digital coupons 179 is a discount 243 that indicates the amount by which a price associated with a respective item 136 listed in a digital coupon 179 is reduced upon purchase as can be appreciated. The discount may be expressed in terms of a dollar amount, percentage of sales price, or in some other manner.

In addition, a multiple usage specification 246 is associated with each of the digital coupons 179. The multiple usage specification 246 indicates how many times a given digital coupon 179 may be used by an individual, a family, or other entity. Specifically, in one embodiment, a toggle indicator 247 is shown that indicates whether a digital coupon 179 may be used only once or multiple times by a given entity. As shown, if the toggle indicator 247 is clicked or otherwise placed in a positive state, then the digital coupon 179 may be used multiple times by a given entity. Otherwise, the digital coupon 179 may only be used once. In another embodiment, a text box 248 is shown in which a vendor may enter the number of times a given entity may use the respective digital coupon 179.

As mention above, the multiple usage specification 246 may be restricted to individual users, family units, or other groupings of persons based, for example, on the information contained in the customer account 153. In one example, the multiple usage specification 246 of a digital coupon 179 is specified for each customer account 153, or for a grouping of related customer accounts 153, etc.

In addition, it may be the case that at a given time, a vendor may have two or more digital coupons 179 active for use by the electronic commerce system 123. In one embodiment, the spreadsheet or user interfaces 189 may allow a vendor to specify that only a single digital coupon 179 is to be presented for a given item 136 at a time to prevent a customer from being able to redeem multiple digital coupons 179 for the same item 136.

The user interface 189b also specifies the usage 249 for each of the digital coupons 179. The usage 249 indicates the number of times a given digital coupon 179 has been redeemed by a customer. Further, each of the digital coupons 179 includes a maximum expenditure limit 253 that indicates the maximum amount that the vendor wishes to spend for the respective digital coupon 179. Also, the budget used 256 for each digital coupon 179 is specified so that the vender can see the current cost incurred due to usage of the coupons 179.

The maximum expenditure limit 253 may specify a threshold at which the digital coupon 179 is no longer offered or is rendered inactive in association with the operation of the electronic commerce system 123 in facilitating the purchase of items 136 so that ultimately the total expenditure under a given digital coupon 179 will not exceed the maximum expenditure limit 253 to the extent possible. In addition, a campaign maximum expenditure limit 263 is specified in association with the promotional campaign 176 as depicted by the user interface 189b. Note that the campaign maximum expenditure limit 263 may cause all of the digital coupons 179 to move to inactive status 229 even though some of the digital coupons 179 have been used more than others as can be appreciated.

Some of the information depicted in the user interfaces 189a (FIG. 2) and 189b (FIG. 3) may be included in a spreadsheet that is uploaded from a client 106, for example, to the self-service portal 126 as mentioned above. Alternatively, such information may be entered into appropriate user interfaces 189 (FIG. 1) rendered on clients 106. In addition, there may be other information specified such spreadsheets or user interfaces 189 beyond the information described above.

The information submitted in a spreadsheet or in user interfaces 189 may include data indicating a group of target customers for each of the digital coupons 179. As a result, the presentation of each of the digital coupons 179 may be focused on target groups of customers. To this end, the spreadsheet or user interface may allow a vendor to indicate coupon targeting information that indicates the customers to which a given digital coupon 179 should be targeted. For example, a vendor may specify a list of products that were previously purchased or viewed through the electronic commerce system 123. Such a list may be associated with individual digital coupons 179 or for all of the digital coupons 179 of a promotional campaign 176 to indiciate that one or more digital coupons 179 should be surfaced to customers that purchased or viewed the products listed. Further a vendor may indicate specific geographical area or location information such as a metropolitan area, a state, a province, or other area in association with a digital coupon 179 or promotional campaign 176 that indicates the location of customer to which the respective one or more digital coupons 179 are to be targeted. Further, a vendor may specify in the spreadsheet or user interface 189 a specific customer demographic of respective customers to which a digital coupon 179 is to be targeted.

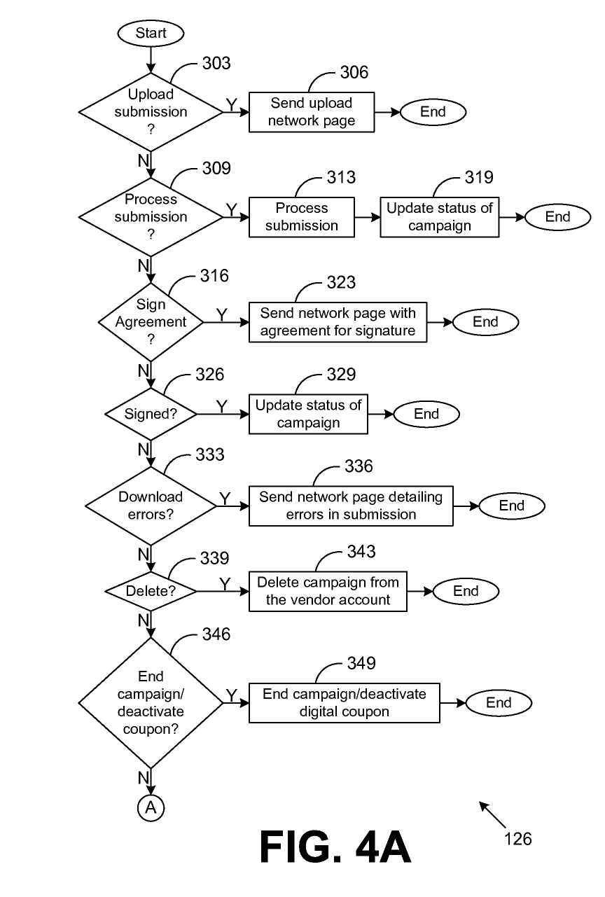

With reference to FIGS. 4A and 4B, shown is a flowchart that provides one example of various functionality of the self-service portal 126 in facilitating interaction with vendors that manipulate clients 106 (FIG. 1) according to various embodiments. Alternatively, the flowchart of FIG. 4 may be viewed as depicting steps of a method implemented in the server 103 (FIG. 1). The flowchart of the self-service portal 126 depicted in FIGS. 4A and 4B is recursive in nature, although other types of programming formats may be employed. The functionality depicted in the flowchart of FIGS. 4A and 4B is implemented each time a request or submission is received from a client 106 that requires action on the part of the self-service portal 126 as can be appreciated. Note that there may be additional functions that are not represented in the flowchart of FIGS. 4A and 4B as can be appreciated.

To begin, in box 303, the self-service portal 126 determines whether a vendor wishes to upload a submission of a spreadsheet or other data specifying one or more promotional campaigns 176 from a client 106. Such a request may be received if a vendor clicks on the button 216 (FIG. 2) indicating the desire to upload a file as described above. Assuming such is the case, then the self-service portal 126 proceeds to box 306 in which one or more network pages that facilitate the upload of a spreadsheet is/are sent to the client 106. Thereafter, the self-service portal 126 ends.

Assuming that the self-service portal 126 has not been requested to upload a given submission in box 303, then in box 309 the self-service portal 126 determines whether a new spreadsheet or other data has been received that needs to be processed or otherwise analyzed for errors. Assuming such is the case, then the self-service portal 126 proceeds to box 313. Otherwise, the self-service portal 126 progresses to box 316.

In box 313, the self-service portal 126 processes the submission by analyzing the same to identify errors and other problems. Note that the submission that is uploaded may be an original submission of a given promotional campaign 176 or a replacement submission for a previously submitted promotional campaign 176 that was found to have significant errors that required resubmission. Thereafter, in box 319, the self-service portal 126 updates the status 209 (FIG. 2) of the respective promotional campaign 176.

In box 316, the self-service portal 126 determines whether the vendor has indicated a desire to sign an agreement associated with a given one of the promotional campaigns 176 or the digital coupons 179. To this end, if such is the case, then in box 323 the self-service portal 126 serves up an appropriate network page that facilitates signing an agreement for the respective promotional campaign 176 or digital coupon 179. Thereafter, the self-service portal 126 ends. Note that where a single digital coupon 179 is included in a given promotional campaign 176, then the agreement is effectively for the digital coupon 179. Although not described specifically above, it may be possible to establish agreements for individual ones of the digital coupons 179 as well where multiple digital coupons 179 are associated with a promotional campaign 176.

Assuming that the user does not wish to sign an agreement as indicated in box 316, then in box 326, the self-service portal 126 determines whether a signature associated with a given promotional campaign 176 or digital coupon 179 has been received from a client 106. If so, then the self-service portal 126 proceeds to box 329. Otherwise, the self-service portal 126 proceeds to box 333.

In box 329, the status 209 of the respective promotional campaign 176 is updated to reflect the fact that it has been signed by the vendor. Alternatively, a status associated with an individual digital coupon 179 may be updated where appropriate. Thereafter, the self-service portal 126 ends as shown.

Assuming that the self-service portal 126 proceeds to box 333, then it is determined whether the client 106 has requested to download errors noted in a given promotional campaign 176 or digital coupon 179. Such a request may be generated if the user manipulates a given action 213 (FIG. 2) that indicates they wish to download the errors indicated in the given promotional campaign 176 as described above. Assuming that such is the case, then the self-service portal 126 proceeds to box 336. Otherwise, the self-service portal 126 progresses to box 339. In box 336, the self-service portal 126 encodes for display a network page that details all errors associated with a given promotional campaign 176 and sends the same to the client 106 in reply to the request. Thereafter, the self-service portal 126 ends.

In box 339, the self-service portal 126 determines whether a given promotional campaign 176 or digital coupon 179 is to be deleted. Such would be the case, for example, if a user implements an action 213 indicating that a promotional campaign 176 or digital coupon 179 is to be deleted. If so, then in box 343 the self-service portal 126 deletes the respective promotional campaign 176 or digital coupon 179 from those listed in association with the vendor. Thereafter, the self-service portal 126 ends.

However, if there is no deletion to be performed in box 339, then in box 346 the self-service portal 126 determines whether it is to end a given promotional campaign 176. Such may be accomplished by clicking on an appropriate action 213 to end a given promotional campaign 176 as described above. If so, then in box 349, the self-service portal 126 proceeds to deactivate the digital coupons 179 associated with a given promotional campaign 176. Assuming that no action is taken to end a promotional campaign 176 in box 346, the self-service portal 126 proceeds to box 353 (FIG. 4B) through connector A.

In box 353, the self-service portal 126 determines whether it is to activate a given digital coupon 179 (FIG. 1) based upon the manipulation of an activate button 231 (FIG. 3) with respect to a given digital coupon 179. Alternatively, a digital coupon 179 may be activated based upon the fact that the start date 236 (FIG. 3) has been reached indicating that the time period for activation of the given digital coupon 179 has started. If such is the case, then the self-service portal 126 proceeds to box 356. Otherwise, the same proceeds to box 359.

In box 356, the self-service portal 126 marks the digital coupon 179 in the data store 113 (FIG. 1) as active to be presented to consumers as part of a network page served up by the electronic commerce system 123 (FIG. 1) as described above. To this end, once the digital coupon 179 is marked as active, the electronic commerce system 123 may be configured to automatically access the digital coupon 179 for inclusion in various network pages. Thereafter, the self-service portal 126 ends as shown.

Assuming that the self-service portal 126 reaches box 359, then it is determined whether a given digital coupon 179 is to be deactivated. Such may occur based upon receipt of a message from a client 106 indicating that a given deactivate button 233 (FIG. 3) has been clicked upon by a user. Alternatively, the end date 239 (FIG. 3) for a respective digital coupon 179 may have been reached. Further, the digital coupon 179 may be subject to deactivation due to the fact that the expenditure under a given digital coupon 179 may have reached a threshold indicating that the maximum expenditure limit 253 (FIG. 3) has been reached or soon will be reached, thereby necessitating the deactivation of the digital coupon 179 as described above. Assuming that the digital coupon 179 is to be deactivated, then the self-service portal 126 proceeds to box 363 in which the digital coupon 179 is marked in the data store 113 as inactive. Thereafter, the self-service portal 126 ends.

Assuming that the self-service portal 126 has proceeded to box 366, then the self-service portal 126 determines whether the maximum expenditure limit threshold associated with either a promotional campaign 176 or a digital coupon 179 has been reached. Note that such a threshold may be determined to be a predefined percentage of the maximum expenditure limit 253/263 (FIG. 3) specified for a given digital coupon 179 or promotional campaign 176. Alternatively, the threshold may actually be equal to the maximum expenditure limit 253/263, where it is possible that outstanding instances of digital coupons 179 that have yet to be redeemed but were served up to clients 106 may still be redeemed by customers, thereby causing the ultimate expenditure to exceed the limit specified by a relatively small amount.

Assuming that the threshold has been reached as determined in box 366, then in box 369 the self-service portal 126 proceeds to implement the deactivation of the respective digital coupon 179 or promotional campaign 176. This may be done in a manner that simply cuts off the use of the respective one or more digital coupons 179 for future purchases.

Alternatively, the digital coupons 179 may be included in a limited number of network pages in a controlled manner such that the amount of outstanding digital coupons 179 at any given time would not cause the maximum expenditure limit 253 to be exceeded if all such digital coupons 179 were redeemed. Thus, the digital coupons 179 may be presented to customers on a limited basis until the maximum expenditure limit 253 has been reached. Alternatively, the digital coupon 179 may simply be deactivated immediately, thereby preventing any further such digital coupons 179 from reaching customers. Thereafter, the self-service portal 126 ends as shown. Note that if the respective threshold has not been reached in box 366, then the self-service portal 126 also ends as shown. Also, additional boxes may be added to the functionality of the self-service portal 126 as depicted in FIGS. 4A and 4B in association with further actions taken in response to requests from the client 106 as described herein.

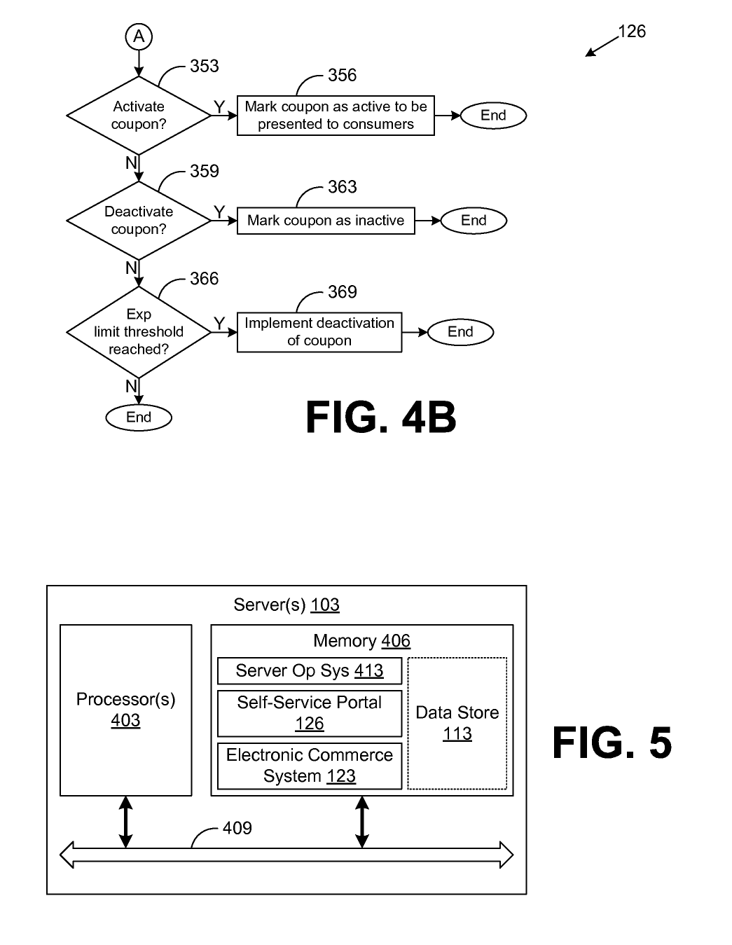

Referring next to FIG. 5, shown is a schematic block diagram of one example of a server 103 according to an embodiment of the present disclosure. The server 103 includes at least one processor circuit, for example, having a processor 403 and a memory 406, both of which are coupled to a local interface 409. To this end, the server 103 may comprise, for example, a server computer system or like device as described above. The local interface 409 may comprise, for example, a data bus with an accompanying address/control bus or other bus structure as can be appreciated.

Stored in the memory 406 are both executable applications and/or systems executed by the processor 403 and data. In particular, stored in the memory 406 and executable by the processor 403 are a server operating system 413, the self-service portal 126, the electronic commerce system 123, and potentially other applications and/or systems, etc. Also, stored in the memory 406 is the data store 113 in which are stored the various data items described above so as to be accessible to the processor 403. It is understood that other data may be stored in the memory 406 and accessed by the processors 403 beyond the data described above.

A number of software components are stored in the memory 406 and are executable or executed by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 406 is defined herein as both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 403 may represent multiple processors and the memory 406 may represent multiple memories that operate in parallel. In such a case, the local interface 409 may be an appropriate network that facilitates communication between any two of the multiple processors, between any processor and any one of the memories, or between any two of the memories etc. The local interface 409 may comprise additional systems designed to coordinate this communication, including, for example, performing load balancing. The processor 403 may be of electrical or of some other available construction.

The various applications or other components described above may be implemented using any one or more of a number of programming languages such as, for example, C, C++, C#, Visual Basic, VBScript, Java, JavaScript, Perl, Ruby, Python, Flash, or other programming languages.

Although the various applications and other components such as the self-service portal 126 and/or the electronic commerce system 123 described above may be embodied in software or code executed by general purpose hardware, as an alternative each may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 4-5 show the functionality and operation of an implementation of the various applications and/or other components such as the self-service portal 126 as described above. If embodied in software, each of the various blocks described may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowcharts of FIG. 4 or 5 show a specific order of execution, it is understood that the order of execution may differ from that which is depicted. For example, the order of execution of two or more blocks may be scrambled relative to the order shown. Also, two or more blocks shown in succession in FIG. 4 or 5 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, where the various applications, systems, and/or other components described herein such as the self-service portal 126 and/or the electronic commerce system 123 comprise software or code, the same can be embodied in any computer-readable medium for use by or in connection with an instruction execution system such as, for example, a processor in a computer system or other system. In this sense, the applications or engines may comprise, for example, statements including instructions and declarations that can be fetched from the computer-readable medium and executed by the instruction execution system. In the context of the present disclosure, a “computer-readable medium” can be any medium that can contain, store, or maintain logic or code for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
at least one computing device;
an electronic commerce system implemented in the at least one computing device, the electronic commerce system facilitating interaction with a plurality of clients over a network to facilitate a purchase of a plurality of items; and
a self-service portal implemented in the computing device, the self-service portal facilitating vendor access to a plurality of coupon campaigns employed in association with an operation of the electronic commerce system, the self-service portal being configured to allow a vendor to:
perform an automated submission to the computing system over a network of each of the campaigns to be employed in association with the operation of the electronic commerce system, each campaign comprising at least one digital coupon;
view a listing of each of the campaigns previously submitted by the vendor through the self-service portal;
view a listing of each of the digital coupons associated with a respective one of the campaigns; and
deactivate all of the digital coupons associated with a respective one of the campaigns that are active to be applied to a purchase of an item through the electronic commerce system.

2. The system of claim 1, wherein the self-service portal is further configured to allow a vendor to specify a maximum expenditure limit associated with each of the digital coupons, where each digital coupon is deactivated for purposes of being applied to the purchase of the item through the electronic commerce system based upon the maximum expenditure limit.

3. The system of claim 2, wherein the self-service portal is configured to deactivate each of the digital coupons when a respective expenditure under each digital coupon reaches a predefined percentage of the maximum expenditure limit associated with each respective digital coupon.

4. A method, comprising the steps of:
implementing a plurality of coupon campaigns in a computing device for a plurality of vendors in association with an electronic commerce system, each of the coupon campaigns comprising at least one digital coupon;
facilitating an automated submission of each of the campaigns in the computing device from respective ones of the vendors through a self-service portal; and
facilitating vendor control through the self-service portal as to whether the digital coupons associated with a respective one of the campaigns are active to be applied to a purchase of an item through the electronic commerce system.

5. The method of claim 4, wherein the step of facilitating vendor control through the self-service portal as to whether the digital coupons associated with the respective one of the campaigns are active further comprises the step of facilitating a vendor specification of a maximum expenditure limit associated with the one of the campaigns.

6. The method of claim 5, wherein the step of deactivating all active ones of the digital coupons associated with the one of the campaigns when a collective expenditure under all of the active ones of the digital coupons associated with the one of the campaigns reaches a predefined percentage of the maximum expenditure limit associated with the campaign.

7. The method of claim 6, further comprising the step of honoring, in the electronic commerce system, any outstanding instances of the digital coupons associated with the one of the campaigns for a predefined period of time after the predefined percentage of the maximum expenditure limit associated with the campaign has been reached.

8. The method of claim 4, further comprising the step of encoding in the computing device a user interface for display on a client, the user interface including a component that facilitates a control by one of the vendors as to when all of the digital coupons associated with a respective one of the campaigns is active.

9. The method of claim 4, further comprising the step of encoding in the computing device a user interface for display on a client, the user interface including a plurality of components associated with corresponding ones of a plurality of digital coupons associated with one of the campaigns, wherein each of the components facilitates deactivation of a respective one of the digital coupons.

10. The method of claim 4, further comprising the step of analyzing each of the campaigns submitted through the self-service portal for errors.

11. The method of claim 4, further comprising the step of facilitating a vendor specification of a maximum expenditure limit associated with respective ones of the digital coupons associated with one of the campaigns.

12. The method of claim 4, wherein the automated submission includes data indicating a group of target customers for each of the digital coupons, wherein each of the digital coupons are to be presented to a respective group of target customers.

13. A system, comprising:
a computing device; and
a self-service portal implemented in the computing device, the self-service portal facilitating vendor access to a plurality of coupon campaigns employed in association with an electronic commerce system, the self-service portal being configured to allow a vendor to:
perform an automated submission of each of the campaigns to be employed in association with the operation of the electronic commerce system, each campaign comprising at least one digital coupon; and
control when each of the digital coupons is active to be applied to a purchase of an item through the electronic commerce system.

14. The system of claim 13, wherein the self-service portal is further configured to allow a vendor to collectively control when all of the digital coupons associated with each of the campaigns is active.

15. The system of claim 13, wherein the self-service portal is further configured to perform an analysis of each of the digital coupons associated with each campaign to identify errors when the campaign is submitted through the self-service portal.

16. The system of claim 13, wherein the self-service portal is configured to allow a vendor to control when each of the digital coupons is active to be applied to the purchase of the item through the electronic commerce system by facilitating a vendor specification of a maximum expenditure limit associated with each of the digital coupons.

17. The system of claim 16, wherein the self-service portal is configured to deactivate an active one of the digital coupons when an expenditure under the active one of the digital coupons reaches a predefined percentage of the maximum expenditure limit.

18. The system of claim 17, wherein any instances of the active one of the digital coupons that have been sent to a client are honored for a predefined period of time after the expenditure under the active one of the digital coupons reaches a predefined percentage of the maximum expenditure limit.

19. The system of claim 13, wherein the self-service portal is configured to encode an interface for display on a client that lists each of the campaigns maintained in association with the electronic commerce system.

20. The system of claim 19, wherein the interface includes a component that facilitates deactivation of active ones of the campaigns.

21. The system of claim 13, wherein the self-service portal is configured to encode an interface for display on a client that lists each of the digital coupons associated with a respective one of the campaigns maintained in association with the electronic commerce system.

22. The system of claim 21, wherein the interface includes a component that facilitates deactivation of active ones of the digital coupons.

23. The system of claim 13, wherein the self-service portal is further configured to provide for an electronic signing with respect to a contract associated with each of the campaigns.
